(19) United States
(12) Patent Application Publication
(10) Pub. No.: US 2021/0224242 A1
(43) Pub. Date: Jul. 22, 2021

(54) SYSTEMS AND METHODS FOR INDEXING AND SEARCHING DATA

(71) Applicant: HARDY-FRANCIS ENTERPRISES INC., Coquitlam (CA)

(72) Inventor: Simon HARDY-FRANCIS, Coquitlam (CA)

(73) Assignee: HARDY-FRANCIS ENTERPRISES INC., Coquitlam (CA)

(21) Appl. No.: 17/059,204

(22) PCT Filed: May 30, 2019
(86) PCT No.: PCT/CA19/50737

§ 371 Date: Nov. 25, 2020

Related U.S. Application Data
(60) Provisional application No. 62/678,924, filed on May 31, 2018.

(51) Int. Cl. G06F 16/22; G06F 16/2455; G06F 16/248; G06F 21/62

(52) U.S. Cl. CPC G06F 16/2282; G06F 16/2455; G06F 21/6227; G06F 21/6254; G06F 16/248

(57) ABSTRACT

Some embodiments include a method for indexing a data item. The method comprises identifying a plurality of characteristics of the data item; for at least one characteristic of the plurality of characteristics of the data item: generating an index based on the at least one characteristic; retrieving, from a data storage, a data structure corresponding to the index; storing a selected value at a location in the data structure, wherein the location in the data structure corresponds to the data item; and storing the data structure back to the data storage. Some embodiments include a method for searching a data collection comprising a plurality of data items based on the data structure.

### RELATED APPLICATIONS

This application claims the benefit under 35 U.S.C. § 119(e) of U.S. Provisional Application Ser. No. 62/678,924, titled “SYSTEMS AND METHODS FOR INDEXING AND SEARCHING DATA” filed May 31, 2018 under Attorney Docket No. H0954.70000US00, the contents of which is herein incorporated by reference in its entirety.

### SUMMARY

Some embodiment provide a method for indexing a data item, the method comprising acts of: identifying a plurality of characteristics of the data item; for at least one characteristic of the plurality of characteristics of the data item: generating an index based on the at least one characteristic; retrieving, from a data storage, a data structure corresponding to the index; storing a selected value at a location in the data structure, wherein the location in the data structure corresponds to the data item; and storing the data structure back to the data storage.

Other embodiments provide a method for searching a plurality of data items, the method comprising acts of: identifying, from a search query, at least one characteristic to be searched; generating at least one index based on the at least one characteristic; retrieving, from a data storage, at least one data structure corresponding to the at least one index; and generating a result for the search query, the result including a data item corresponding to a location in the at least one data structure where a selected value is stored, wherein each location in the at least one data structure where the selected value is stored corresponds to a data item matching the at least one characteristic.

Further embodiments provide at least one non-transitory computer-readable medium having encoded thereon instructions which, when executed by at least one processor, cause the at least one processor to perform a method for indexing a data item, the method comprising: identifying a plurality of characteristics of the data item; for at least one characteristic of the plurality of characteristics of the data item: generating an index based on the at least one characteristic; retrieving, from a data storage, a data structure corresponding to the index, wherein the data storage stores a bitmap table having a plurality of rows, the plurality of rows correspond, respectively, to a plurality of data items, the plurality of data items comprising the data item, and the data structure retrieved from the data storage comprises a column in the bitmap table; storing a selected value at a location in the data structure, wherein the location in the data structure corresponds to the data item, and storing a selected value in the data structure comprises setting a bit in the column at a bit offset corresponding to the data item; and storing the data structure back to the data storage.

### BRIEF DESCRIPTION OF DRAWINGS

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1 is an illustrative indexing and searching system 100, in accordance with some embodiments;

FIG. 2 shows an illustrative bitmap table 200 that is generated and used for indexing and searching data items of a data collection, in accordance with some embodiments;

FIGS. 3A-3B show, respectively, illustrative processes 300 and 320 for indexing a data item, in accordance with some embodiments;

FIGS. 4A-4B show, respectively, illustrative processes 400 and 420 for searching a data collection comprising a plurality of data items, in accordance with some embodiments;

FIG. 5 is a block diagram of an example computer system, in accordance with some embodiments.

### DETAILED DESCRIPTION

The inventor has recognized and appreciated that in some indexing and searching systems, index data may be stored in a database in a plurality of rows, and all or a large number of rows may be fetched at search time to locate one or more data items that satisfy a search query. For a large database of index data, the fetching of rows and further processing to locate data items may consume significant amounts of processor, memory, and/or communication resources. In some embodiments, an indexing scheme may be provided to reduce consumption of computational resources at search time.

The inventor has further recognized and appreciated that in some indexing and searching systems, a search program may run close to index data. For example, the search program may run on a computing device on which the index data is also stored. In some instances, the search program and the index data may be both located locally (e.g. on a desktop computer, or a mobile device such as a smart phone, a tablet device, etc.), or both located remotely (e.g. on a server provided by a cloud computing service).

The inventor has recognized and appreciated that in systems where both the search program and the index data are located on a local computing device, indexing and/or searching operations may be limited by availability of local resources (e.g., processor and/or memory resources). Also, only a limited amount of index data may be stored due to competing demands for storage capacity of the local computing device. On the other hand, in systems where both the search program and the index data are located on a remote computing device, search terms and/or other data may be communicated from a user device to the remote device via one or more networks. Such systems may be susceptible to malicious attacks, which may lead to data breaches. For example, when searching via a web browser running on a desktop computer, search terms entered via a webpage associated with a search engine may be communicated to a remote server where both the search engine and index data are located. If the index data stored on the remote server is encrypted, an encryption key may also be sent to and/or stored on the remote server via one or more networks. Practical implementations of such an architecture may be replete with vulnerabilities that may be exploited by malicious entities.

Accordingly, in some embodiments, an architecture may be provided where a search program and index data may be decoupled. For instance, the search program may be run on a local computing device, while the index data may be stored at a remote server.

The inventor has recognized and appreciated various advantages of such an architecture. For instance, in some embodiments, index data may be stored at the remote server in encrypted form. During a search operation, some of the index data may be sent to the local device in encrypted form, and the local device may decrypt the index data prior to searching. In this manner, both search terms and a key for decrypting the index data may remain on the local device, thereby eliminating a risk of the search terms and the decryption key being intercepted during transit. Moreover, the search terms and the decryption key may not be susceptible to malicious attacks on the remote server or mishandling by employees who manage the remote server.

In some embodiments, any one or more encryption techniques may be used to encrypt the index data. Examples of suitable encryption techniques include, but are not limited to, any Advanced Encryption Standard algorithm (e.g., AES256). In some embodiments, both encryption and decryption of the index data may be performed by the local device. This may allow a user to select a suitable encryption technique, for example, based on a desired tradeoff between speed and security.

In some embodiments, the index data may be stored as files on file servers, rather than more expensive search program servers. The inventor has recognized and appreciated that serving files from file servers in response to search queries may consume significantly lower computational resources in comparison to servicing search queries using a conventional server side index such as Elasticsearch. The inventor has further recognized and appreciated that file servers may scale more economically than search program servers. An online service that to deploys and maintains a number of search program servers may be able to reduce costs by switching off many search program servers and using the index data stored on file servers instead.

The inventor has recognized and appreciated that some indexing systems only support full-text searching, especially where encryption is involved. For instance, partial matching (e.g., returning results for “text,” “Texas,” and “TeX” as a user types in “tex”) may be challenging in an indexing system where each word is translated into an encrypted counterpart (e.g., a ciphertext for “tex” may not be a substring of a ciphertext for “Texas”). Furthermore, although each word may be encrypted in an index, an attacker may be able to see how frequently certain ciphertexts occur, and may be able to draw inferences from the observed frequencies. This may lead to various amounts of data leakage. Accordingly, in some embodiments, an indexing system may be provided that allows partial matching, even with an encrypted index.

The inventor has further recognized and appreciated that an encrypted index may be larger than an original index from which the encrypted index is generated. For instance, in some indexing systems, individual fields in an index database may be separately encrypted. Because each ciphertext tends to be much larger than a corresponding plaintext, separate encryption of individual fields may lead to a significant increase in size for the database overall. Therefore, more storage space may be occupied by an encrypted index. Moreover, certain encryption techniques may be more vulnerable when applied more times on smaller pieces of data (e.g., individual words), as opposed to fewer times on larger pieces of data.

Accordingly, in some embodiments, an indexing scheme may be provided with an encrypted index that is more compact and/or more secure. For instance, an index may be encrypted on a column-by-column basis, as opposed to a field-by-field basis.

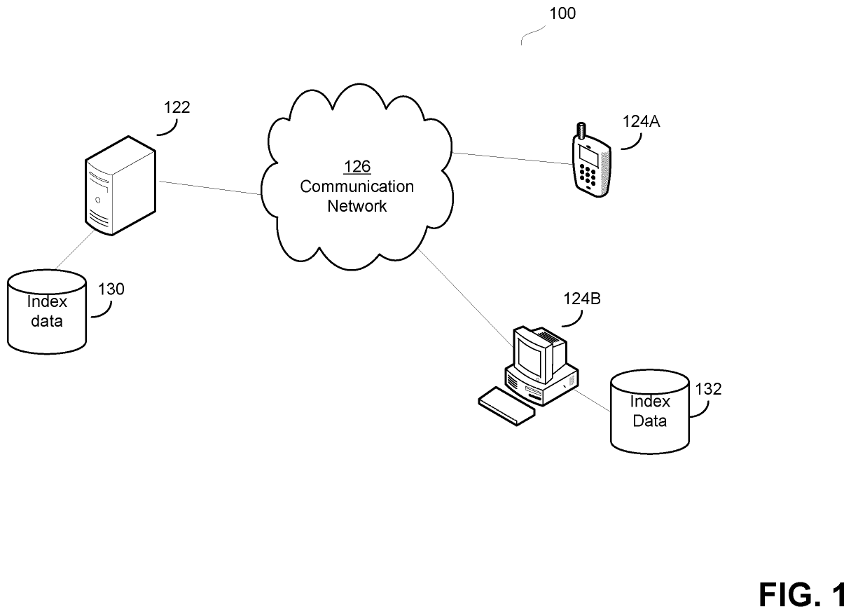

FIG. 1 shows an illustrative indexing and searching system 100, in accordance with some embodiments. In this example, the system 100 includes one or more client devices, such as a smart phone 124A and a desktop computer 124B. Although not shown, other types of client devices (e.g., a laptop computer, a tablet device, etc.) may be used in addition to, or instead of, the smart phone 124A and the desktop computer 124B. The system 100 may also include one or more server devices, such as a server 122. The one or more client devices and the one or more server devices may be configured to communicate via one or more communication networks, such as a communication network 126.

In some embodiments, index data may be stored locally at the client device 124B, and/or in a data storage 132 communicably coupled to the client device 124B. A connection between the data storage 132 and the client device 124B may be a wired connection (e.g., USB, Ethenet, etc.) or a wireless connection (e.g., WiFi, Bluetooth, etc.). In some embodiments, the connection between the client device 124B and the data storage 132 may be more secure than a connection between the client device 124B and the server 122. For instance, the network 126 may include a public network, whereas the client device 124B and the data storage 132 may be connected directly to each other, or via a private network.

Additionally, or alternatively, index data may be stored remotely at the server device 122, and/or in a data storage 130 communicably coupled to the server device 122. In some embodiments, the data storage 130 may be a file system, a database, or any Application Programming Interface (API) that may be used to persist the data, and likewise for the data storage 132.

In some embodiments, index data stored locally may be accessed to search for data items of a locally stored data collection that match a search query entered at the client device 124B. In some embodiments, index data stored remotely may be accessed to search for data items of a remotely stored data collection that match a search query entered at the client device 124A or the client device 124B. However, it should be appreciated that aspects of the present disclosure are not limited to storing a data collection and an index therefor at a same location. In some embodiments, index data stored locally may be accessed to search for data items of a remotely stored data collection, or vice versa.

In some embodiments, index data may be stored in a compressed form, an encrypted form, or some suitable combination of both. It should be appreciated that when stored in a compressed and/or encrypted form, the index data may be decompressed and/or decrypted, and re-compressed and/or re-encrypted, as appropriate during indexing and/or searching. A same compression technique or a different one may be used for the re-compression. Likewise, a same encryption technique or a different one, and/or a same encryption key or a different one, may be used for the re-encryption.

In some embodiments, index data may be stored in a bitmap table where each row may be associated with a data item in a data collection, and each column may be associated with a possible search term. In some embodiments, a plurality of columns may be associated with a character string that a user may enter in a search query. For instance, the character string may have a plurality of substrings, and each column of the plurality of columns may correspond to a respective substring of the plurality of substrings.

In some embodiments, one or more columns of the bitmap map table may be stored as a file. The inventor has recognized and appreciated that storing columns as files may facilitate efficient searching. For instance, in response to a search query comprising a search term, a file storing one or more columns associated with the search term may be fetched and processed, without having to access all rows of the bitmap table. In this manner, an amount of data that is accessed, transmitted, and/or processed in response to a search query may be considerably reduced, thereby reducing consumption of computational and/or communication resources.

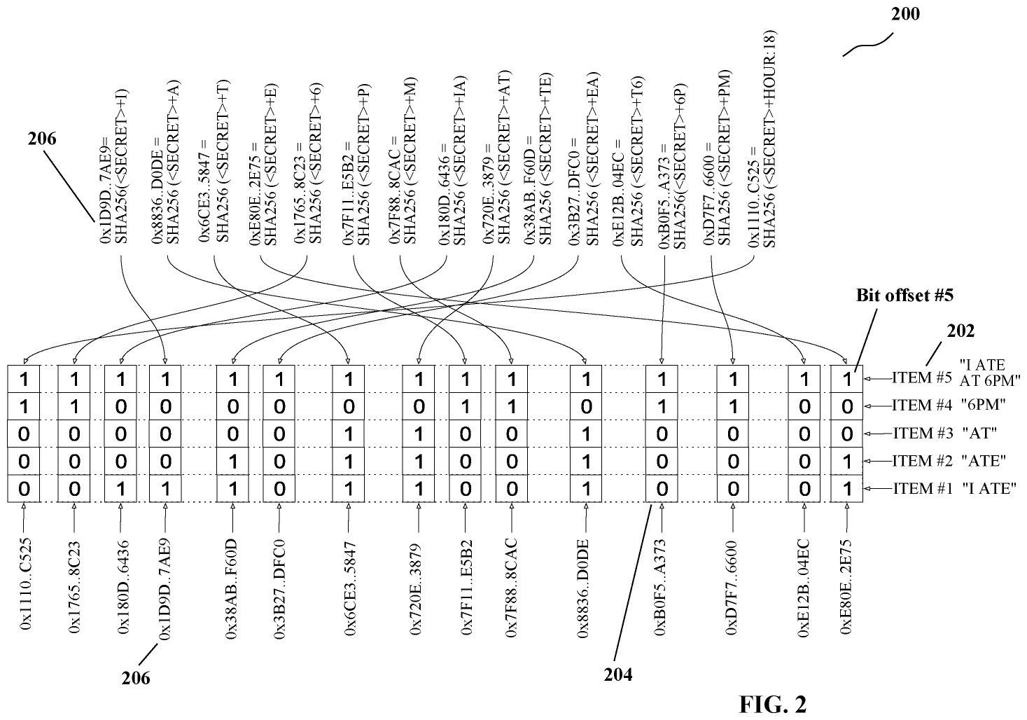

FIG. 2 shows an illustrative bitmap table 200 that is generated and used for indexing and searching data items of a data collection, in accordance with some embodiments. In this example, a data item includes a file or document containing text and/or metadata. In some embodiments, metadata may be derived from textual content. For instance, a data item may contain a text string “6 PM,” as well as metadata “HOUR:18.” Additionally, or alternatively, other types of metadata may be included, such as a “last modified” time stamp provided by an operating system, an identifier for a user who created the data item, etc.

In the example depicted in FIG. 2, each row (e.g., row 202) of the bitmap table corresponds to a data item, such as item #1, item #2, item #3, item #4, and item #5, and each column (e.g., column 204) of the bitmap table stores a column bitmap index associated with a possible search term. In some embodiments, a search term may be a substring of a word, which may allow partial text search. In some embodiments, a search term may be an entire word, which may allow full text search. In some embodiments, a search term may represent a piece of metadata (“HOUR:18”), which may allow searching based on metadata.

FIG. 2 depicts fifteen illustrative column bitmap indices for search terms “I”, “A”, “T”, “E”, “6”, “P”, “M”, “IA”, “AT”, “TE”, “EA”, “T6”, “6P”, “PM”, and “HOUR:18.” Each entry in a column bitmap index indicates whether the search term is present in the data item associated with a row in which the entry is located. Therefore, in this example, there are as many bits in the column bitmap index as data items in the data collection.

In some embodiments, a column bitmap index may be identified using a hash generated by applying a suitable hash function to the search term and/or a secret. For instance, in the example of FIG. 2, the column bitmap index name 206 is a hash of the search term “I” and a secret. This hash may be an output of the SHA-256 hash function, and may be a 64 digit hex numeral that is represented in a truncated form in FIG. 2, showing only the first four and the last four hex digits (“0x1D9D..7AE9”).

Any suitable secret may be used to generate a hash. For instance, a secret may include some information associated with a user (e.g., a password). In this manner, when a same search term is hashed twice, each time with a different password (e.g., associated with a different user), an attacker may not be able to detect that the resulting hashes were generated from the same search term. Additionally, or alternatively, a secret may include a salt, which may introduce randomness. In this manner, when a same search term is hashed twice, each time with a different salt, an attacker may not be able to detect that the resulting hashes were generated from the same search term.

Below are illustrative hash outputs of the same text ‘foo’ with the same password, but different salts.

$ perl -e ‘use Digest::SHA; $password=q[mypass]; $salt=q[123]; $secret=$password. $salt; printf qq[0x % s\n], Digest::SHA::sha256_hex(qq[foo]. $secret);’ 0xd7a3eb04ef9054d8fa8e76d8ac2f29fe3330dad04e35bf0e76f1f272481a9725
$ perl -e ‘use Digest::SHA; $password=q[mypass]; $salt=44561; $secret=$password. $salt; printf qq[0x % s\n], Digest::SHA::sha256_hex(qq[foo]. $secret);’ 0xb2cb980e7357a5dff8021a05d805512113f74fa26004f97d88ed1cc4d7c48c26

Thus, “d7a3eb04 ef9054d8 fa8e76d8 ac2f29fe 3330dad04e35bf0e 76f1f272 481a9725.txt” may be used as a file name for a column associated with the search term “foo” for user X, whereas “b2cb980e 7357a5df f8021a05 d8055121 13f74fa2 6004f97d 88ed1cc4 d7c48c26.txt” may be used as a file name for a column associated with the same search term “foo” for user Y, even if the two users happen to use the same password. As long as a fresh salt is chosen for each user, a likelihood of generating a same file name may be extremely low. In some embodiments, a bitmap table may be stored along with an index description, which may include housekeeping information, such as a salt used for generating column identifiers, a number of rows (which may be the same as a number of data items in the data collection), indication of one or more types of metadata based on which the data items have been indexed, whether the data items have been indexed based on partial words or only full words, size of partial words (e.g., maximum substring length), etc.

In some embodiments, a number of possible columns in the bitmap table may be controlled by selecting a suitable hash function. For instance, the hash function SHA-256 has a 256 bit output. Thus, there may be at most 2\hat{ }256 columns. In practice, a much smaller number of columns may be used, corresponding respectively to all possible search terms (e.g., character strings appearing in the data collection, and/or substrings thereof). Such a bitmap table may be considered “sparse,” and may be stored efficiently, for example, by only storing columns corresponding to search terms.

The inventor has recognized and appreciated that it may be desirable to use a hash function with a low likelihood of collision. For instance, a SHA-256 collision may be considered impossible for practical purposes, so that no two different search terms may be hashed to a same value. Therefore, each search term may be represented with just one column. However, it should be appreciated that aspects of the present disclosure are not limited to using just one column to represent a search term.

The inventor has recognized and appreciated various advantages provided by the illustrative indexing techniques described above in connection with FIG. 2. For instance, a bitmap table generated for a data collection having ten million data items and one million possible search terms may have ten million rows and one million columns. To find data items matching two search terms, only two columns may be retrieved and processed, in accordance with some embodiments. By contrast, in some indexing systems, an entire bitmap table may be retrieved and processed, including all one million columns. Thus, one or more of the techniques described herein may be used to reduce consumption of computational resources (e.g., processor, memory, etc.) and/or communication resources (e.g., network bandwidth) by orders of magnitude.

Continuing with the above example, each column may include 10 million bits, which may be about 1.2 MB in size in an uncompressed and encrypted form. If a cellular phone having a download speed of about 41 Mbps is used, it may take about ⅕^{th} of a second to download two 1.2 MB files (storing, respectively, the two columns corresponding to the two search terms). Thus, the download may be performed in the background in a transparent manner, for example, as a user types in a search term at a normal touch typing speed. By contrast, in an indexing system that retrieves an entire bitmap table, 1.2 TB of data may be downloaded (one million 1.2 MB files), which may take over 27 hours at a speed of about 41 Mbps.

In some embodiments, column files may be downloaded from a data storage service (e.g., DropBox, Google Drive, Amazon S3, etc.), which may be less costly than a search service.

In some embodiments, a bit offset N (e.g., 1,234,567) being set within a retrieved column may indicate that data item #N (e.g., #1,234,567) may include the search term associated with the retrieved column. In some embodiments, a name of the data item #N may be recovered by applying a hash function (e.g., SHA-256) to the bit offset N (e.g., 1,234,567), the password, and/or the salt. For example, “38b060a7 51ac9638 4cd9327e b1b1e36a 21fdb711 14be0743 4c0cc7bf 63f6e1da.txt” may be the name of the data item #1,234,567.

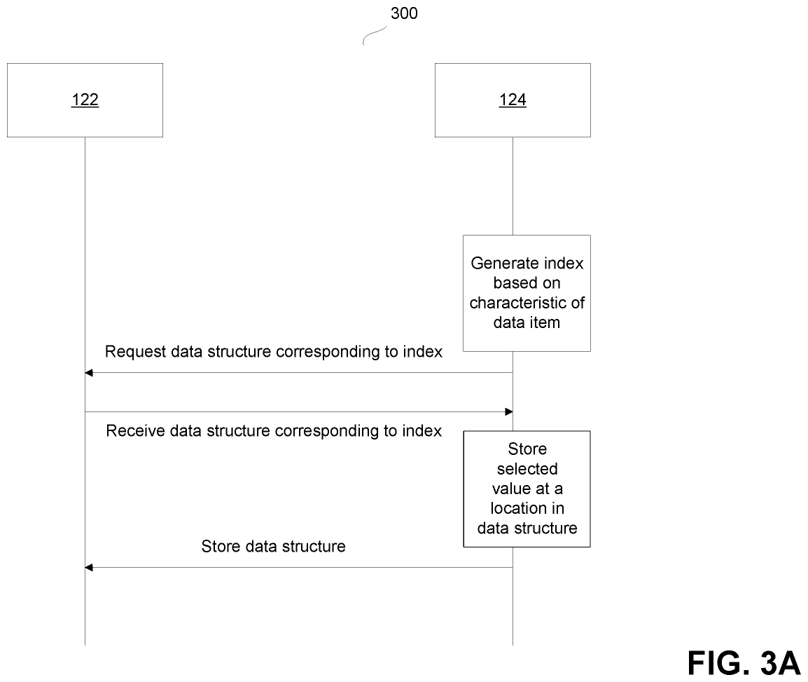

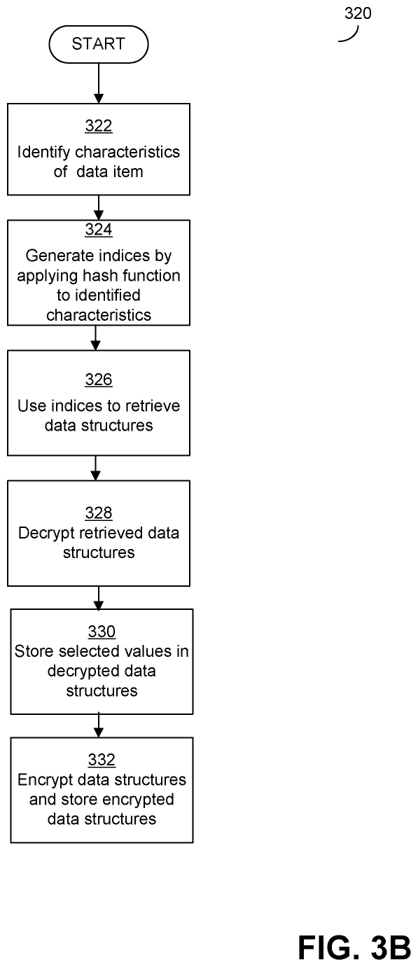

FIGS. 3A-3B show, respectively, illustrative processes 300 and 320 for indexing a data item, in accordance with some embodiments. For instance, the processes 300 and 320 may be used by a client device 124 (e.g., the illustrative smart phone 124A or the illustrative desktop computer 124B in the example of FIG. 1) to retrieve and/or store index data. In some embodiments, the index data may be retrieved from, and/or stored to, a server (e.g., the illustrative server 122 in the example of FIG. 1).

In the example shown in FIGS. 3A-3B, index data may be retrieved and stored in response to a data item (e.g., data item #5 in the example of FIG. 2) being added to a data collection (e.g., existing data items #1 through #4). For instance, whenever a new data item is added, a bitmap table (e.g., the illustrative bitmap table 200) may be updated, for example, by writing a selected value (e.g., a 1 bit) to one or more columns at a bit offset corresponding to the new data item.

At act 322 of FIG. 3B, the client device 124 may identify one or more characteristics of a data item. The one or more characteristics may include one or more substrings of a character string in the data item. For example, for the data item #5 in the example of FIG. 2, a plurality of substrings associated with the character string “I ATE AT 6 PM” may be identified (with spaces removed). In some embodiments, each substring of the plurality of substrings may have a length that is no greater than a maximum substring length defined in an index description. For example, if the maximum substring length is 2, the plurality of substrings of data item #5 may be identified as “I”, “A”, “T”, “E”, “6”, “P”, “M”, “IA”, “AT”, “TE”, “EA”, “T6”, “6P”, “PM”.

Additionally, or alternatively, the one or more characteristics may include metadata associated with the data item. Additionally, or alternatively, the one or more characteristics may include a canonical representation of a semantic entity represented by a character string in the data item. The inventor has recognized and appreciated that a text-based search may sometimes fail to uncover semantic matches. For instance, a search for “6 PM” may fail to uncover data items comprising “18:00,” “6:00 PM,” “6 o'clock in the evening,” etc. Accordingly, in some embodiments, a canonical representation (e.g., “HOUR:18”) may be used to allow semantic searching.

In some embodiments, a data item may include occurrences of the same character string in different contexts (e.g., “6 PM” in the subject line of an email, as well as in the body of the email). Thus, there may be a first characteristic corresponding to the character string in a first context, and a second characteristic corresponding to the same character string in a second context different from the first context.

At act 324 of FIG. 3B, the client device 124 may generate an index for each of the one or more characteristics identified at act 322. For example, for the identified substring “I” of the data item #5, an index may be generated by applying a hash function to the substring “I” and/or a secret.

At act 326 of FIG. 3B, the client device 124 may use the one or more indices generated at act 324 to retrieve one or more corresponding data structures. In some embodiments, the client device 124 may retrieve one or more data structures from an internal storage. Additionally, or alternatively, the client device 124 may retrieve one or more data structures from an external storage (e.g., the illustrative data storage 132 in the example of FIG. 1). Additionally, or alternatively, the client device 124 may retrieve one or more data structures from the server 122. For example, as shown in FIG. 3A, the client device 124 may communicate, to the server 122, a request comprising one or more of the indices generated at act 324. In response to the request, the server 122 may use the one or more indices to fetch one or more corresponding data structures from an internal storage of the server 122 and/or an external storage (e.g., the illustrative data storage 130 in the example of FIG. 1). The server 122 may send the fetched one or more data structures to the client device 124.

In some embodiments, the one or more data structures may comprise one or more columns from a bitmap table (e.g., the illustrative bitmap table 200 in the example of FIG. 2).

In some embodiments, the one or more data structures may be stored, fetched, and/or sent by the server 122 in an encrypted form. At act 328, the client 124 may decrypt the one or to more data structures using a suitable decryption key. In some embodiments, the same password and/or salt used for generating indices may also be used for a decryption key. However, aspects of the present disclosure are not so limited.

In some embodiments, a symmetric encryption technique may be used, so that a same key may be used both for encryption and for decryption. Alternatively, or additionally, an asymmetric encryption technique may be used, so that a public key may be used for encryption whereas a secret key may be used for decryption.

In some embodiments, at act 330, the client device 124 may store a selected value (e.g., a 1 bit) at a location in each retrieved data structure, where the location in the data structure corresponds to the data item being processed. With reference to the example shown in FIG. 2, each retrieved data structure may be a column, and a bit may be set to 1 in each retrieved column at a bit offset corresponding to the data item (e.g., bit offset #5). Thus, bits at bit offset #5 for all columns shown in FIG. 2 are set to 1.

In some embodiments, a requested data structure may not already exist. For instance, in the example shown in FIG. 2, existing data items do not include the substrings “EA” and “T6,” and therefore the client device 124 may be unable to find, from the internal storage, the external storage 132, or the server 122, columns corresponding to the substrings “EA” and “T6.” In response, the client device 124 may create columns for the substrings “EA” and “T6,” where each column may store the bit string 10000 and may be indexed using a hash value generated from the corresponding substring and/or the secret.

At act 332 of FIG. 3B, the client device 124 may encrypt one or more processed data structures (e.g., one or more retrieved data structures with the selected value stored, and/or one or more newly created data structures). In some embodiments, an encryption technique that was previously used to encrypt a data structures may be used again, with a same encryption key or a different one. Alternatively, or additionally, a different encryption technique may be used.

At act 332 of FIG. 3B, one or more encrypted data structures may be stored, for example, back to the internal storage, the external storage 132, and/or the server 122.

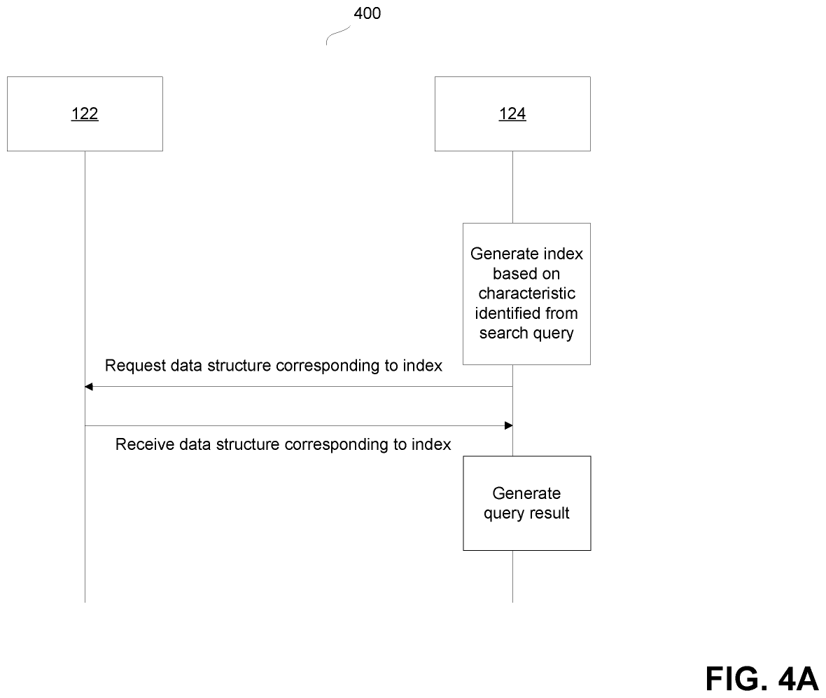

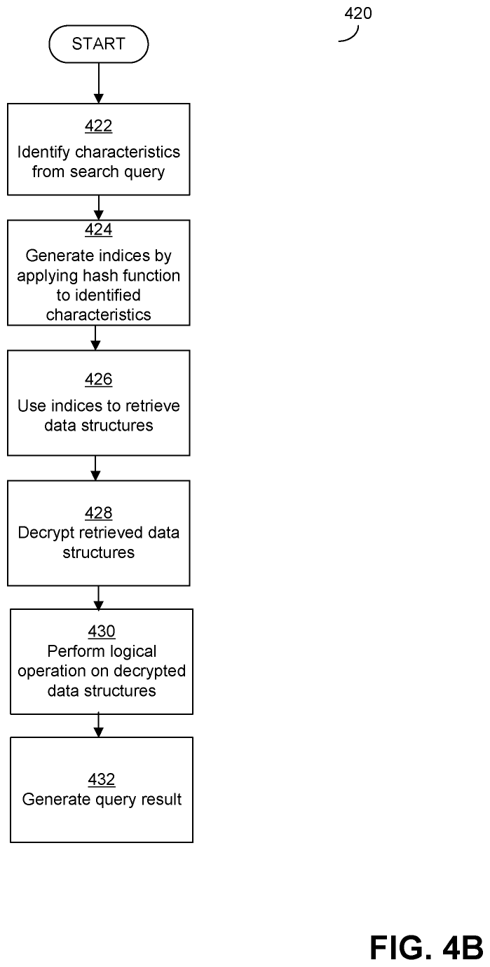

FIGS. 4A-4B show, respectively, illustrative processes 400 and 420 for searching a data collection comprising a plurality of data items, in accordance with some embodiments. For instance, the processes 400 and 420 may be used by a client device 124 (e.g., the illustrative smart phone 124A or the illustrative desktop computer 124B in the example of FIG. 1) to retrieve index data in response to a search query comprising one or more search terms. In some embodiments, the index data may be retrieved from a server (e.g., the illustrative server 122 in the example of FIG. 1)

At act 422 of FIG. 4B, the client device 124 may identify the one or more characteristics from the search query. For example, with reference to the example shown in FIG. 2, a search query may include search terms “ATE” and “6,” and a plurality of substrings associated with the search terms may be identified. In some embodiments, each substring of the plurality of substrings may have a length that is no greater than a maximum substring length defined in an index description. For instance, if the maximum substring length is 2, the plurality of substrings may be identified “AT”, TE”, and “6.”

In some embodiments, an identified characteristic may include a canonical representation of a semantic entity represented by a character string in the search query (e.g., “HOUR:18” for “6 PM”). In some embodiments, an identified characteristic may include a character string to be searched and an associated context in which to search for the character string (e.g., “6 PM” in the subject line of an email, or in the body of the email).

At act 424 of FIG. 4B, an index may be generated for each of the one or more characteristics identified at act 422. For instance, for the identified substring “AT,” an index may be generated by applying a hash function to the substring “AT” and/or a secret.

At act 426 of FIG. 4B, the client device 124 may use one or more indices identified at act 424 to retrieve one or more corresponding data structures. In some embodiments, the client device 124 may retrieve one or more data structures from an internal storage. Additionally, or alternatively, the client device 124 may retrieve one or more data structures from an external storage (e.g., the illustrative data storage 132 in the example of FIG. 1). Additionally, or alternatively, the client device 124 may retrieve one or more data structures from the server 122. For example, as shown in FIG. 4A, the client device 124 may communicate, to the server 122, a request comprising one or more of the indices generated at act 424. In response to the request, the server 122 may use the one or more indices to fetch one or more corresponding data structures from an internal storage of the server 122 and/or an external storage (e.g., the illustrative data storage 130 in the example of FIG. 1). The server 122 may send the fetched one or more data structures to the client device 124.

In some embodiments, the one or more data structures may comprise one or more columns from a bitmap table. For instance, three columns corresponding respectively to substrings “AT”, “TE” and “6” may be fetched, out of the fifteen columns in the illustrative to bitmap table 200 in the example of FIG. 2.

In some embodiments, the one or more data structures may be stored, fetched, and/or sent by the server 122 in an encrypted form. At act 428, the client 124 may decrypt the one or more data structures using a suitable decryption key. In some embodiments, the same password and/or salt used for generating indices may also be used for a decryption key. However, aspects of the present disclosure are not so limited.

In some embodiments, a symmetric encryption technique may be used, so that a same key may be used both for encryption and for decryption. Alternatively, or additionally, an asymmetric encryption technique may be used, so that a public key may be used for encryption whereas a secret key may be used for decryption.

At act 430 of FIG. 4B, the client device 124 may perform one or more logical operations on one or more decrypted data structures. With reference to the example shown in FIG. 2, a logical AND operation may be performed on the three columns corresponding respectively to the substrings “AT”, “TE” and “6.” In this example, 10111 AND 10011 AND 11000 results in 10000, indicating only the data item #5 includes both of the search terms “ATE” and “6”. At act 432 of FIG. 4B, the client device 124 may generate a result for the search query based on a result of the one or more logical operations performed at act 430. For example, the data item #5 may be returned as a search result.

It should be appreciated that the techniques disclosed herein may be implemented in any of numerous ways, as the disclosed techniques are not limited to any particular manner of implementation. Examples of details of implementation are provided solely for illustrative purposes. Furthermore, the disclosed techniques may be used individually or in any suitable combination, as aspects of the present disclosure are not limited to the use of any particular technique or combination of techniques.

The inventor has recognized and appreciated various advantages of techniques disclosed herein. For instance, in some embodiments, secret values such as encryption keys, passwords and/or salts for generating indices, etc. may never leave a client device. This may improve security of an encrypted data collection and/or encrypted index data stored on an untrusted server. In some embodiments, no decryption may be performed on an untrusted server. Any suitable encryption technique be used. However, aspects of the present disclosure are not limited to the use of encryption.

In some embodiments, no information may be leaked to a server. As one example, hash values used as column indices may reveal no information about the search terms or the secret used to generate the hash values. As another example, an encrypted column may reveal no information about the corresponding search term, or about data items in the data collection.

In some embodiments, even if two users happen to use the same password, have the same data items, and search for the same search terms, the use of different salts for the users may result in different sets file names for the two users, and/or different encrypted column files. Therefore, no correlation may be detected.

In some embodiments, only a single column may be retrieved by a client device per search term, which may be a tiny fraction of a total number of columns. As a result, such retrieval may scale well, remaining fast even when a number of data items increases significantly.

In some embodiments, only one bit may be stored to link a search term to a data item, regardless of a size of the data item. For instance, a bit may be set at a column corresponding to the search term and a row corresponding to the data item. This may allow more search terms to be indexed, including partial words, thereby enabling partial text search. In some embodiments, partial text search may be supported even when an indexing system is scaled to serve a large number of users. By contrast, other indexing systems may support full text search only because an amount of index data becomes prohibitively large when partial words are included.

In some embodiments, columns having only zeros may not be stored, further reducing storage footprint.

In some embodiments, search logic and index data may be separated, so that if the index data is stored on a remote server, the remote server may only serve files (e.g., files corresponding to columns in a bitmap table) from file servers, and may therefore consume significantly lower computational resources in comparison to a server that uses a server side index such as Elasticsearch to respond to search queries. Such savings may be achieved whether or not encryption is used.

In some embodiments, a low cost or even free service (e.g. DropBox, Google Drive, Amazon S3, etc.) may be used to store index data. Such flexibility may be provided whether or not encryption is used. By contrast, other indexing systems require expensive infrastructures with special-purpose search servers.

In some embodiments, any suitable synchronization service such as DropBox may be to used to synchronize local index data with one or more remote copies. This may allow a user to maintain multiple copies of the index data, for example, on various local devices (e.g., desktop, laptop, etc.) for offline usage, and/or in the cloud for access by a thin client (e.g., a web browser or an app running on a smart phone that does not have sufficient storage capacity to maintain the index data locally). Such synchronization may be performed whether or not encryption is used.

### Illustrative Use Cases

To further illustrate aspects of the techniques described herein, three use cases are described below.

Encrypted local and remote index: Consider a user with a laptop at home. On the laptop's hard disk are all encrypted data items in a data collection (e.g. files, emails, etc), together with encrypted index data (e.g., a column bitmap index collection including all column bitmap indices for all possible search terms). Therefore, on that laptop searches may be performed locally because all data including the index data is on the laptop. However, the encrypted files may be synchronized to a cloud service such as DropBox. Now, consider a scenario where the user wants to search the encrypted data collection but does not have his/her laptop available. In this scenario, using a thin client such as a browser or a smart phone application, the user may search the remote encrypted data collection and column bitmap index collection (on DropBox in this example), but the password used for encryption and/or hashing may never leave the thin client, and no search term data may be leaked to the remote service (DropBox in this example).

Unencrypted remote index: An online web service such as Wikipedia may have a huge amount of data which may be searched by users. Data is not necessarily encrypted. Currently there are around 50 million searches per day. Many expensive search servers are deployed and maintained to fulfill the search demand. By using aspects of the present disclosure without encryption, column bitmap index collection files may be stored on cheaper file servers such as Amazon S3, and the search business logic may be moved from expensive search servers to thin clients (e.g. browsers) of the Wikipedia users. The costs for running expensive search servers may be saved.

Not-necessarily encrypted embedded index: Consider a service (e.g., storage, email, instant messaging, etc.) using miscellaneous technology (e.g., client server, cloud, peer to peer, distributed, blockchain, etc.) where the storage location of the not-necessarily encrypted service to data collection is unknown (e.g. local, remote, remote distributed peer to peer, remote distributed cloud, etc.) but can be accessed (e.g. stored and retrieved) via software (e.g., an App, program, API, protocol, etc.) so that a not-necessarily encrypted index can be embedded into the service for both indexing and searching, without necessarily knowing the service storage location of the not-necessarily encrypted index.

Example Computing Device

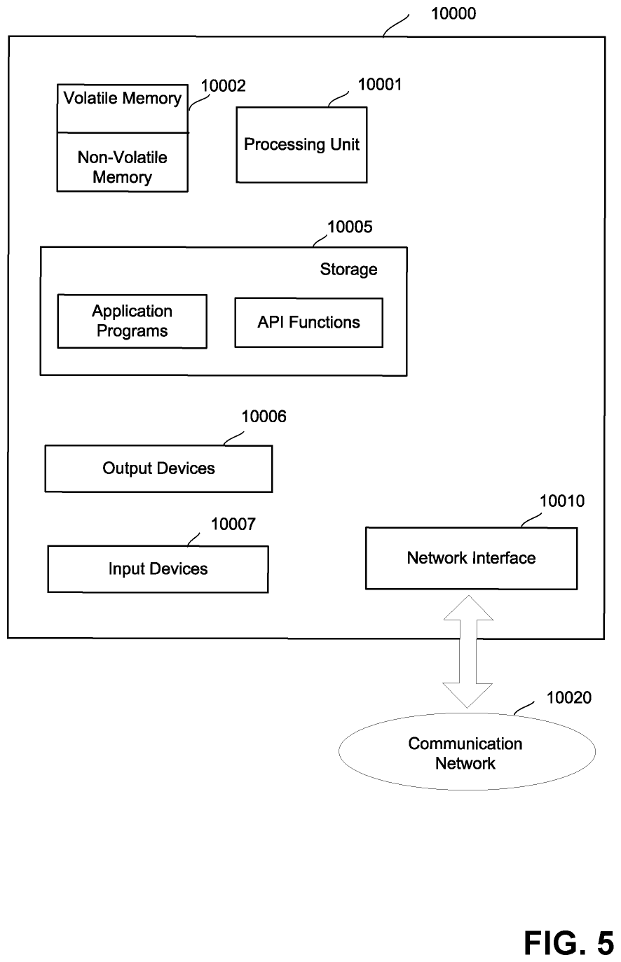

FIG. 5 shows, schematically, an illustrative computer 10000 on which any aspect of the present disclosure may be implemented. In the embodiment shown in FIG. 5, the computer 10000 includes a processing unit 10001 having one or more processors and a non-transitory computer-readable storage medium 10002 that may include, for example, volatile and/or non-volatile memory. The memory 10002 may store one or more instructions to program the processing unit 10001 to perform any of the functions described herein. The computer 10000 may also include other types of non-transitory computer-readable medium, such as storage 10005 (e.g., one or more disk drives) in addition to the system memory 10002. The storage 10005 may also store one or more application programs and/or external components used by application programs (e.g., software libraries), which may be loaded into the memory 10002.

The computer 10000 may have one or more input devices and/or output devices, such as devices 10006 and 10007 illustrated in FIG. 5. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards and pointing devices, such as mice, touch pads, and digitizing tablets. As another example, the input devices 10007 may include a microphone for capturing audio signals, and the output devices 10006 may include a display screen for visually rendering, and/or a speaker for audibly rendering, recognized text.

As shown in FIG. 5, the computer 10000 may also comprise one or more network interfaces (e.g., the network interface 10010) to enable communication via various networks (e.g., the network 10020). Examples of networks include a local area network or a wide area network, such as an enterprise network or the Internet. Such networks may be based on any suitable technology and may operate according to any suitable protocol and may include wireless networks, wired networks or fiber optic networks.

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing description and drawings are by way of example only.

The above-described embodiments of the present disclosure can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the concepts disclosed herein may be embodied as a non-transitory computer-readable medium (or multiple computer-readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the present disclosure discussed above. The computer-readable medium or media can be transportable, such that the program or programs stored thereon can be loaded onto one or more different computers or other processors to implement various aspects of the present disclosure as discussed above.

The terms “program” or “software” are used herein to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various features and aspects of the present disclosure may be used alone, in any combination of two or more, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the concepts disclosed herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

What is claimed is:

1. A method for indexing a data item, the method comprising acts of:
identifying a plurality of characteristics of the data item;
for at least one characteristic of the plurality of characteristics of the data item:
generating an index based on the at least one characteristic;
retrieving, from a data storage, a data structure corresponding to the index;
storing a selected value at a location in the data structure, wherein the location in the data structure corresponds to the data item; and
storing the data structure back to the data storage.

2. The method of claim 1, wherein the act of generating an index comprises:
applying a hash function to the at least one characteristic and/or at least one security value, wherein the at least one security value comprises a password and a salt.

3. The method of claim 2, wherein the data structure retrieved from the data storage is in encrypted form, and wherein the method further comprises acts of:
prior to storing the selected value at the location in the data structure, using the password and the salt to decrypt the data structure; and
after storing the selected value at the location in the data structure, using the password and the salt to encrypt the data structure, so that the data structure is stored back to the data storage in encrypted form.

4. The method of claim 1, wherein:
the data storage stores a bitmap table having a plurality of rows;
the plurality of rows correspond, respectively, to a plurality of data items, the plurality of data items comprising the data item; and
the data structure retrieved from the data storage comprises a column in the bitmap table, wherein the act of storing a selected value in the data structure comprises:
setting a bit in the column at a bit offset corresponding to the data item.

5. The method of claim 1, wherein:
the plurality of characteristics comprise a plurality of substrings of a character string in the data item; and
each substring of the plurality of substrings has a length no greater than a selected limit.

6. The method of claim 1, wherein the act of identifying a plurality of characteristics of the character string comprises:
identifying a character string in the data item; and
mapping the character string to the at least one characteristic, wherein the at least one characteristic comprises a canonical representation of a semantic entity represented by the character string.

7. The method of claim 1, wherein the plurality of characteristics comprise first and second characteristics, and wherein the act of identifying a plurality of characteristics of the data item comprises:
identifying a first occurrence of a character string in a first context in the data item;
identifying a second occurrence of the character string in a second context in the data item, the second context being different from the first context;
mapping the first occurrence of the character string to the first characteristic; and
mapping the second occurrence of the character string to the second characteristic, wherein the acts of generating an index, retrieving a data structure, storing a selected value in the data structure, and storing the data structure are performed separately for each of the first characteristic and the second characteristic.

8. A method for searching a plurality of data items, the method comprising acts of:
identifying, from a search query, at least one characteristic to be searched;
generating at least one index based on the at least one characteristic;
retrieving, from a data storage, at least one data structure corresponding to the at least one index; and
generating a result for the search query, the result including a data item corresponding to a location in the at least one data structure where a selected value is stored, wherein each location in the at least one data structure where the selected value is stored corresponds to a data item matching the at least one characteristic.

9. The method of claim 8, wherein the act of generating the at least one index comprises:
applying a hash function to the at least one characteristic and/or at least one security value, wherein the at least one security value comprises a password and a salt.

10. The method of claim 9, wherein the at least one data structure retrieved from the data storage is in encrypted form, and wherein the method further comprises acts of:
using the password and the salt to decrypt the at least one data structure prior to generating the result for the search query.

11. The method of claim 8, wherein the act of retrieving the at least one data structure corresponding to the at least one index comprises:
transmitting, via at least one network, a request for the at least one data structure, the request comprising the at least one index generated based on the at least one characteristic; and
receiving, via the at least one network, the data structure corresponding to the at least one index.

12. The method of claim 8, wherein the act of retrieving the at least one data structure corresponding to the at least one index comprises:
retrieving, from a local data storage, the at least one data structure corresponding to the at least one index.

13. The method of claim 8, wherein the act of retrieving the at least one data structure corresponding to the at least one index comprises:
retrieving a plurality of data structures corresponding, respectively, to a plurality of indices, wherein the plurality of indices are generated based, respectively, on a plurality of characteristics identified from the search query.

14. The method of claim 13, wherein the plurality of data structures comprises a plurality of columns of a bitmap table stored in the data storage.

15. The method of claim 13, wherein the act of generating a result for the search query comprises:
combining the plurality of data structures to yield a combined data structure.

16. The method of claim 15, wherein the act of combining the plurality of data structures comprises performing a logical operation on the plurality of data structures to yield the combined data structure.

17. The method of claim 8, wherein:
the data storage stores a bitmap table having a plurality of rows;
the plurality of rows correspond, respectively, to the plurality of data items; and
the at least one data structure retrieved from the data storage comprises at least one column in the bitmap table.

18. The method of claim 8, wherein:
the at least one characteristic comprises at least one substring of a character string in the search query; and
the at least one substring has a length no greater than a selected limit.

19. The method of claim 8, wherein the act of identifying, from a search query, at least one characteristic to be searched comprises:
identifying a character string in the search query; and
mapping the character string to the at least one characteristic, wherein the at least one characteristic comprises a canonical representation of a semantic entity represented by the character string.

20. At least one non-transitory computer-readable medium having encoded thereon instructions which, when executed by at least one processor, cause the at least one processor to perform a method for indexing a data item, the method comprising:
identifying a plurality of characteristics of the data item;
for at least one characteristic of the plurality of characteristics of the data item:
generating an index based on the at least one characteristic;
retrieving, from a data storage, a data structure corresponding to the index, wherein the data storage stores a table having a plurality of rows, the plurality of rows correspond, respectively, to a plurality of data items, the plurality of data items comprising the data item, and the data structure retrieved from the data storage comprises a column in the table;
storing a selected value at a location in the data structure, wherein the location in the data structure corresponds to the data item, and storing a selected value in the data structure comprises setting a value in the column at an offset corresponding to the data to item; and
storing the data structure back to the data storage.
